(19) United States
(12) Patent Application Publication
(10) Pub. No.: US 2022/0290964 A1
(43) Pub. Date: Sep. 15, 2022

(54) METHOD AND SYSTEM FOR TACTILE MEASUREMENT, IN PARTICULAR LAYER THICKNESS MEASUREMENT

(71) Applicant: HELMUT FISCHER GMBH INSTITUT FÜR ELEKTRONIK UND MESSTECHNIK, Sindelfingen (DE)

(72) Inventor: Bernd Binder, Waldenbuch (DE)

(21) Appl. No.: 17/688,593

(22) Filed: Mar. 7, 2022

(30) Foreign Application Priority Data
Mar. 12, 2021 (DE) 102021106126.1

(51) Int. Cl. G01B 5/06; G01B 11/00; G06T 11/00; G06F 3/14

(52) U.S. Cl. CPC G01B 5/066; G01B 11/002; G06T 11/00; G06F 3/14; G06T 2210/62

(57) ABSTRACT

A tactile layer thickness measurement is performed on a surface of a measurement object, in which at least one measurement value is detected by means of a tactile measuring probe. The at least one measurement value is transmitted by a data processing device to a pair of data glasses, and the at least one measurement value is reproduced in the data glasses. The system comprises at least one measuring probe, data glasses and a data processing device. The system is designed to carry out the method for tactile layer thickness measurement on the surface of the measurement object.

### CROSS REFERENCE TO RELATED APPLICATIONS

The present application claims priority under 35 U.S.C. § 119(a) to German Patent Application No. 10 2021 106 126.1, filed on Mar. 12, 2021, and entitled “METHOD AND SYSTEM FOR TACTILE MEASUREMENT, IN PARTICULAR LAYER THICKNESS MEASUREMENT,” which is incorporated by reference herein.

### FIELD

The disclosure relates to a method for tactile measurement, in particular layer thickness measurement, and to a system for performing the method.

### BACKGROUND

Surfaces of industrial plants, vehicles, ships, buildings, and other industrial goods are nowadays treated with protective coatings, for example a varnish, to prevent or at least slow down wear and tear. Rust protection coatings are a typical example. Due to the influence of ultraviolet radiation and climatic effects, such protective coatings must be renewed regularly. However, a new coat should not be applied over an existing one at predetermined intervals. Such a procedure would have many disadvantages. It would lead to an increasing layer thickness with each measure and thus to an increase in weight, which can be problematic due to the static load-bearing capacities (e.g., on a suspension bridge). Such an approach would also be cost-intensive. In addition, the wear and tear on the industrial object may vary locally. This is the case, for example, with ship hulls below and above the waterline or also with free-standing industrial plants with regard to the weather side and sides of other orientation.

For these reasons, coating thickness measurements are typically carried out to determine the degree of wear or the remaining coating thickness of the previously applied coating before applying a new protective coating. Due to the size or complexity of the installations in question, a large number of measurements have to be taken at different measurement positions to determine the coating thickness. In order to be able to draw reliable conclusions about the quality of the existing protective layer, the measurement positions must be defined. In other words, a grid of measurement positions must be defined for the particular plant, which can be worked through during the re-inspection. The (re-)finding of the various measurement positions regularly poses a problem. Deviations from the specified measurement positions can lead to falsified measurements and thus to erroneous conclusions.

If there is a deviation between the actual measurement position and the target measurement position in previous checks, an additional complication is that a measurement that is faulty due to the deviation is usually only noticed during the evaluation of the measurement, and thus no longer during the performance of the measurement itself on site. If this measurement position is to be checked again, an additional measurement measure must be carried out, such as placing a weight or requesting a lifting platform or roping down on buildings or objects, which involves a lot of work.

The European Patent Application No. EP 2 386 822 A2 describes a method and a device for measuring the thickness of thin layers on large-area surfaces to be measured, in which at least one measuring probe, which has at least one sensor element and at least one associated contact spherical cap, is placed on the surface to be measured to record a measurement value. The measuring probe is then guided with a device over the surface to be measured in order to record equidistant measurement points along individual lines, which are subsequently evaluated in the form of a matrix. The reproducibility and comparability of successive measurements depends here, for example, on the device being guided along the same lines by the user.

Thus, there is a need to provide a method for tactile (contact-based) measurement, in particular layer thickness measurement, and a system for carrying out the method, whereby a simplification in the execution of measurements and an improved comparability of measurements is made possible.

### SUMMARY

A method for tactile (contact-based) measurement on a surface of a measurement object, in particular layer thickness measurement, records at least one measurement value by means of a tactile measuring probe and transmits it to a pair of data glasses by means of a data processing device. In addition, the at least one measurement value is displayed in the data glasses using image presentation means. Through the image presentation of the measurement value, in particular through a display, in the data glasses, the user who is carrying out the measurement receives direct feedback about the measurement value. The user may continue in the test routine without looking at a display of a separate or additional device. The user can thus immediately perceive whether, for example, a measurement has been taken or has failed, so that in the latter case the measurement can be taken again or made up for without delay.

The tactile measuring probe can be used for contact-based measurement of layer thicknesses, corrosion protection, material testing, temperature testing or surface testing of the surface of the measurement object.

In an embodiment of the method, it is provided that an image presentation in the data glasses is at least partially transparent (“semi-transparent”), so that the image presentation is superimposed with real information from the actual environment. If the image presentation is at least partially transparent, the glasses can reproduce a “mixed reality”. In this context, a mixed reality is to be understood as the superimposition of a virtual reality and a physical reality. The user can therefore perceive both the information generated by the data glasses and the real physical measurement object at the same time. The user does not have to avert their gaze from the measurement object. This prevents the image display from distracting the user. In addition, the user can check the environment and the measurement position personally.

For example, the data glasses may be video glasses. The image presentation means of the data glasses then comprise at least visual image presentation means, for example a display or a projection device such as a digital camera, to enable image presentation on a surface such as a glasses lens. The data glasses may also be glasses capable of reproducing virtual reality. The image presentation means of the data glasses are arranged so that the image display is in the user's field of view.

In an embodiment, the data glasses can also display an augmented reality, i.e., an extension of the perception of reality by information from other sensory organs, which can be reproduced overlaid accordingly.

In an embodiment, the at least one measurement value is correlated by the data processing device with at least one piece of quality information. The measurement value with the relevant correlated quality information is then transmitted to the data glasses and reproduced there. The quality information is to be understood to mean information that indicates whether or not the recorded measurement value corresponds to a predefined value. In this way, deviating measurement values can be marked in an efficient manner and made available to the user. For example, the image presentation of the at least one piece of surface information of the measurement object can be modified accordingly so that the user notices an unforeseen deviation and can take a control measurement if necessary. For example, the measurement value can be output in a colour, in particular green, to signal that the measurement value corresponds to a predetermined value. The measurement value can also be output in a bold font if it corresponds to the predefined value and in a thin font if the measurement value is outside the predefined range.

In an embodiment, the at least one measurement value is correlated by the data processing device with at least one upper and/or one lower limit value of a limit value range. The limit values, which can be defined beforehand and stored in the data processing device, enable a very simple and comprehensible determination of the quality information. The user can then also easily detect significant deviations and carry out corresponding control measurements, especially if the limit values are reproduced together with the measurement value. For example, the measurement value can be displayed in a first colour if it is within the limit values and in a second, different colour otherwise.

In an embodiment, the upper and/or lower limit value of the expected value range of the measurement value can then be transmitted to the data glasses and reproduced there.

In an embodiment, the method provides that at least one piece of surface information of the measurement object is provided to the data glasses and is reproduced by the data glasses. The surface information can be a spatially resolved surface presentation of the measurement object. It can also be only partial areas of the measurement object. It may be possible to switch between an image presentation of the at least one piece of surface information and an image presentation of the at least one measurement value. Alternatively, the image presentations of the surface information and the at least one measurement value can be superimposed or arranged next to each other. Furthermore, the image presentation of the surface information can also be at least partially transparent. This means that both the image presentation of the at least one measurement value can be superimposed on the surface information and that both can be individually superimposed on the real information of the measurement object. In this way, the user of the data glasses can compare the real physical appearance of the measurement object with the surface information and additionally can perceive also the at least one recorded measurement value.

The data processing device can be coupled to a local or remote data storage device to retrieve and provide the corresponding surface information of the measurement object.

The data processing device includes at least a microprocessor (“CPU”). The data processing device can further comprise a microcontroller and conventional peripheral components to receive, process and transmit the at least one measurement value from the sensor element to the data glasses.

In an embodiment, the method provides that the data processing device of the data glasses provides at least one target measurement position at which at least one measurement value is to be determined. The at least one piece of surface information of the measurement object can also be reproduced with the at least one target measurement position superimposed. In addition, the at least one piece of surface information can be reproduced with the target measurement position before a measurement value is detected by the data glasses. The image presentation of the surface information with the target measurement position can be at least partially transparent. The target measurement position indicates within the surface information, i.e., within the spatially resolved surface presentation of the measurement object, at which point of the surface of the measurement object a measurement value is to be determined. This provides direct user guidance for positioning the measuring probe on the surface of the measurement object. The superimposed image display shows the user the relevant target measurement position before a measurement value is recorded. Since the user can perceive not only the image presentation of the surface information including the target measurement position, but also the real information of the environment at the same time, the user is then able to place the tactile measuring probe on the surface at the specified target measurement position and to record a measurement value. Faulty measurements resulting from spatial deviations between the target measurement position and the actual measurement position, i.e., the actual position at which a measurement value was recorded, can therefore advantageously be avoided. In an embodiment, the method is used with predefined test plans. In this way, the testing time and the error rate can be reduced.

In an embodiment, a measurement value detected by an image display is assigned to the particular target measurement position. Through the assignment, the data processing device can then change to a subsequent target measurement position according to a routine, which in turn is transmitted to the data glasses and reproduced there.

In an embodiment, it is provided that the at least one piece of surface information with the at least one target measurement position is at least partially correlated by the data processing device with measurement values of the tactile measuring probe. The information correlated in this way is then transmitted to the data glasses. Consequently, the data glasses can then reproduce the spatially resolved surface presentation of the measurement object with the previous and/or current measurement values of the tactile measuring probe. Alternatively, a spatially resolved surface presentation of the measurement object can be reproduced in relation to a difference between previous and current measurement values of the tactile measuring probe. The image presentation of the measuring probe and/or target measurement positions and/or the spatially resolved surface presentation can be at least partially transparent. The spatially resolved surface presentation can be modified, in particular, as a function of currently recorded measurement values or measurement values recorded in the past or a difference between these.

For example, the surface presentation of the measurement object can be at least partially coloured to indicate at which target measurement positions no measurement values have yet been recorded or at which measurement values have already been recorded, or at which measurement values have been recorded in the past and/or are at which measurement values are to be recorded. Coloring can also be implemented according to the particular difference in order to visually display the degree of deviation in an easily detectable way. In addition, target measurement positions can also be displayed with a list of past and/or currently recorded measurement values. By superimposing real information, the user receives a comprehensive information image of the measurement values already recorded or still to be recorded, and coded/assigned to the particular target measurement positions within the spatially resolved surface presentation. The user guidance is therefore significantly improved. It can also be provided that measurement values that were recorded in the past are already displayed to the user before a corresponding measurement value is recorded. In this respect, the previous measurement values are assigned to the relevant target measurement position.

In an embodiment, the surface information of the measurement object is provided by a data memory coupled to the data processing device and/or by a LIDAR (“Light detection and ranging”) sensor element. The LIDAR sensor element is arranged on the data glasses. In the present context, LIDAR is to be understood as a measurement method based on an optical distance measurement for recording and providing the spatially resolved surface presentation of the measurement object. Because the LIDAR sensor element is arranged on the data glasses, the measurement object is detected by the LIDAR sensor element in the same way as the user perceives the real spatial image of the measurement object. This is advantageous if the image presentation in the data glasses is at least partially transparent from the at least one piece of surface information, since no perspective distortions have to be compensated for. In addition, by using current measurement data of the LIDAR sensor element, a change, for example a structural change, of the measurement object can be depicted.

In an embodiment, the LIDAR sensor element can also be arranged independently of the data glasses. For example, the LIDAR sensor element can be mounted on a mobile device, with the help of which the measurement object can be captured in its entirety. The data processing device can then provide the measurement data captured by the LIDAR sensor element to the data glasses in such a way that the spatially resolved surface presentation of the measurement object corresponds to the perspective view from the data glasses.

In an embodiment, the measurement value is correlated with position quality information by the data processing device. The position quality information can indicate the extent to which the actual measurement position corresponds to the target measurement position. The measurement value correlated with the relevant correlated position quality information is then transmitted to the data glasses and reproduced there. For evaluation, corresponding feedback can be provided to the data processing device, for example by input from the user. Thus, the comparability of measurements can be improved.

In an embodiment, the position quality information indicates whether a distance between an actual measurement position and a target measurement position is less than a limit distance. Furthermore, the actual measurement position at which a measurement value was detected can be provided by a position detection element coupled to the tactile measuring probe. The limit distance ensures that the measurement value is detected within a maximum spatial deviation from the target measurement position according to the limit distance specification. The limit distance allows the position quality information to indicate whether a detected measurement value is acceptable with respect to the actual measurement position. The spatially resolved surface presentation of the measurement object can be at least partially coloured with respect to the position quality information, in particular depending on whether the limit distance for an actual measurement position is undershot or exceeded relative to the target measurement position. The position detection element can be a GPS sensor or similar sensor that provides corresponding location coordinates. The arrangement of the position detection element on the tactile sensor element makes it possible to determine the position of the actual measurement position particularly precisely. The position detection element can also be coupled to the tactile measuring probe so that the measurement value detected by the tactile measuring probe is determined simultaneously with the corresponding location coordinates.

In an embodiment, each detected measurement value can also be correlated with the corresponding actual measurement position by the data processing device and provided to the data glasses for image presentation there.

In an embodiment, at least one piece of additional information is transmitted by the data processing device to the data glasses and reproduced there. The additional information may comprise a target area measurement region and/or a target measurement point and/or a repetition level of the target measurement point. The particular additional information is reproduced before or also during the detection of a measurement value. The spatially resolved surface presentation of the measurement object may be divided into a plurality of target area measurement regions. Within each target area measurement region, at least one target measurement point, or a plurality of target measurement points, is provided in the same and/or different target measurement positions within the target surface region. For each target measurement point, several repetition stages, i.e., a certain number of measurements to be carried out, are provided. The corresponding additional information can then be displayed to the user by the data glasses before and/or during the acquisition of a particular measurement value. This improves user guidance because the particular additional information is provided to the user in order to record the measurement value according to the specifications. Thus, the user can work through a given test pattern particularly easily and efficiently. The spatially resolved surface presentation can be at least partially coloured and/or optically highlighted according to the target area measurement region and/or the target measurement point and/or the repetition stage in order to provide the user with further visual assistance. After measurement, this can be indicated by a signal, such as a colour.

In an embodiment, the data processing device may be provided externally to the measuring probe. The measuring probe can be wired to the data processing device for data transmission via an interface, for example with a circuit provided in the interface, in order to transmit the data according to the USB protocol or the UART protocol. This can also be done wirelessly and encrypted. Alternatively, the data processing device can also be separate from the measuring probe and data glasses or integrated in the data glasses.

With regard to the data transmission, this takes place wirelessly between the tactile measuring probe and the data processing device and/or between the data processing device and the data glasses. This allows the data processing device to be located independently of the measuring probe and the data glasses, for example in a service vehicle. The user can then work through a test pattern on the measurement object with a relatively manageable sensor element and the data glasses, without having to carry unwieldy electronic components. In particular, communication can take place using a Bluetooth standard, Bluetooth low-energy standard, such as Zigbee, or a WLAN or another radio standard.

The data glasses can switch between the above-described image presentation types or can superimpose them on each other. In addition, any image presentation can be at least partially transparent, so that the image presentation for the user is superimposed with real information of the environment or the measurement object. The user is thus provided with an immediate image presentation of all relevant and available information, while still being able to perceive the real measurement object. Despite the perception of the real physical measurement object, the user is able to assess the particular measurement values and information on the basis of the measurement object. The user can then notice particularities of the recorded measurement values or the corresponding information during the measurement process and can take appropriate measures, such as additional measurements for specific measurement points. This makes the overall measurement process more efficient, because there is no need to wait for a downstream evaluation before noticing special features. This avoids the need to run another test cycle to clarify any remaining peculiarities. The test procedure as a whole is greatly accelerated.

In an embodiment, the data processing device can make use of a corresponding application software (app), which can be executable locally or decentralized.

The application software and/or the data glasses may provide interaction capabilities to set the appropriate image display mode of the data glasses according to the information to be displayed other than the measurement value.

In an embodiment, the system comprises at least one measuring probe, a pair of data glasses and a data processing device. The system is designed to carry out the method for tactile layer thickness measurement on a surface of a measurement object as described above. The components of the system are coordinated with each other for communication.

In an embodiment, the data glasses also fulfil the function of protective glasses, which is particularly advantageous for large-scale installations.

Other embodiments and details thereof are described and explained in more detail below with reference to the examples shown in the drawings. The features to be taken from the description and the drawings can be used individually or in any combination.

### BRIEF DESCRIPTION OF THE DRAWINGS

FIG. 1 is a schematic depiction of a system for carrying out a method for tactile layer thickness measurement on a surface of a measurement object;

FIG. 2 is a schematic depiction of an image presentation in a pair of data glasses;

FIG. 3 is a schematic depiction of a further image presentation of the measurement object with superimposed user guidance; and

FIG. 4 is a schematic depiction of a further image presentation of the measurement object with measurement value and additional information.

### DETAILED DESCRIPTION

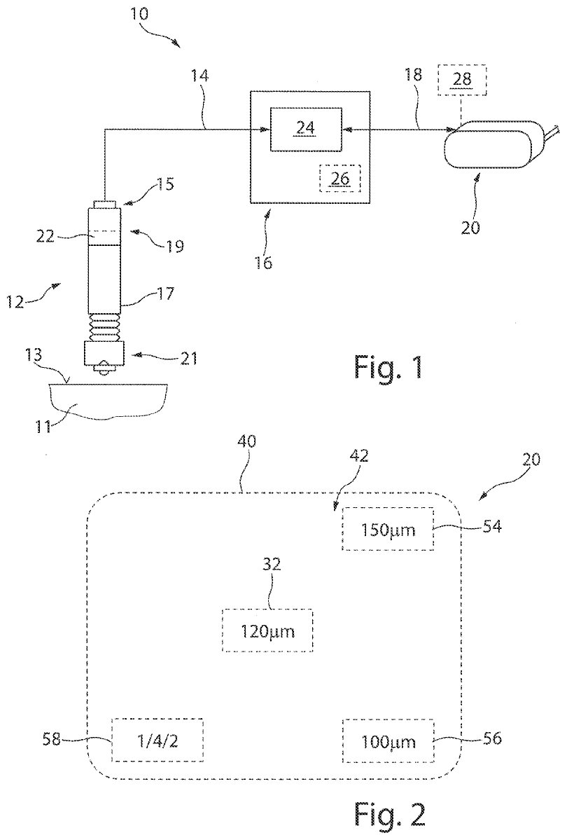

FIG. 1 shows a schematically simplified system 10 for carrying out a method for tactile layer thickness measurement on a surface 13 of a measurement object 11. Such measurement objects 11 can be large-area objects or objects of which the surfaces are difficult to access. For example, tanks, bridges, container or cargo ships or other metal walls with a surface coating, in particular lacquers or the like, may be provided. The system 10 comprises a tactile measuring probe 12 for coating thickness measurements. The system 10 further comprises a data processing device 16. The tactile measuring probe 12 is coupled to the data processing device 16 for data transmission through an interface 15 by means of a wireless or wired data transmission mechanism 14. A circuit 19 may be associated with the interface 15 in a housing 17 of the measuring probe to control the transmission of data. The measuring probe 12 comprises a measuring head 21, which is placed on the surface 13 of the measurement object for measuring—for example—a layer thickness. The system 10 further comprises a pair of data glasses 20. The data processing device 16 is coupled to the data glasses 20 by means of a wireless or wired data transmission mechanism 18. The data processing device 16 may be integrated in the measuring probe 12 or in the data glasses 20. Also, the data processing device 16 may be provided in a mobile device or a stationary device. An application software (app) 24 may be stored in the data processing device 16 for evaluation and communication. The data glasses 20 are, for example, video glasses by means of which an augmented reality can be visually displayed. For this purpose, the data glasses 20 are designed in the present case as video glasses with a digital camera as a projection means. In this way, data, information and/or measurement values can be projected into the user's field of vision as an image presentation.

The data transmission mechanisms 14, 18 may be based on a Bluetooth low-energy standard, in particular the Zigbee transmission protocol. The data transmission mechanism 14 from the tactile measuring probe 12 to the data processing device 16 is unidirectional. Alternatively, it can also be bidirectional. The data transmission mechanism 18 between the data processing device 18 and the data glasses 20 is bidirectional.

Optionally, a position detection element 22 may be fixedly coupled to or disposed within the tactile measuring probe 12.

Further, a local or remote data memory 26 may be provided to support operations performed by the data processing device 16 or to retrieve information, data or measurement values from past measurements.

The local data memory 26 may be integrated in the measuring probe 12 or the data glasses 20. The remote data memory 26 can be a laptop or similar, which is carried by the user.

Furthermore, the system 10 may comprise a LIDAR sensor element 28. The LIDAR sensor element 28 may be arranged on the data glasses 20. The LIDAR sensor element 28 enables measurement data of positions on the surface 11 of the measurement object 11 to be acquired, thereby allowing a spatially resolved surface presentation of the measurement positions on the measurement object 11.

For tactile layer thickness measurement on the surface 13 of the measurement object, the tactile measuring probe 12 is placed at least once on the same measurement position, and at least one measurement value 32 is recorded by the measuring probe 12 and transmitted to the data processing device 16.

The position on the measurement object 11 detected by the LIDAR sensor element 28 is transmitted to the data processing device 16.

At least target values for the layer thickness or other data to be detected are stored in the data memory 26. In an embodiment, a predefined test pattern is stored, according to which the measurement object 11 is to be examined.

FIG. 2 schematically shows a projection surface 40 in the data glasses 20. Within the projection surface 40, various visual presentations 42 can be selected and adjusted. For example, a measurement value 32 can be displayed in a field. This measurement value 32 is the currently recorded measurement value.

Furthermore, an upper limit value can be displayed in a field 54 and a lower limit value in a field 56. These limit values 54, 56 can be based on the current measurement position or on stored data. If, for example, the current measurement value 32 is within the limit values, this can also be displayed visually and/or confirmed with an acoustic signal. Alternatively, the visual and/or acoustic signal for the detection of a measurement value 32 within the upper and lower limit values 54, 56 can also be provided exclusively, without visual information being displayed with regard to the upper and lower limit values 54, 56.

Furthermore, additional information 58 can be displayed, for example, which is discussed in more detail below with reference to FIG. 4.

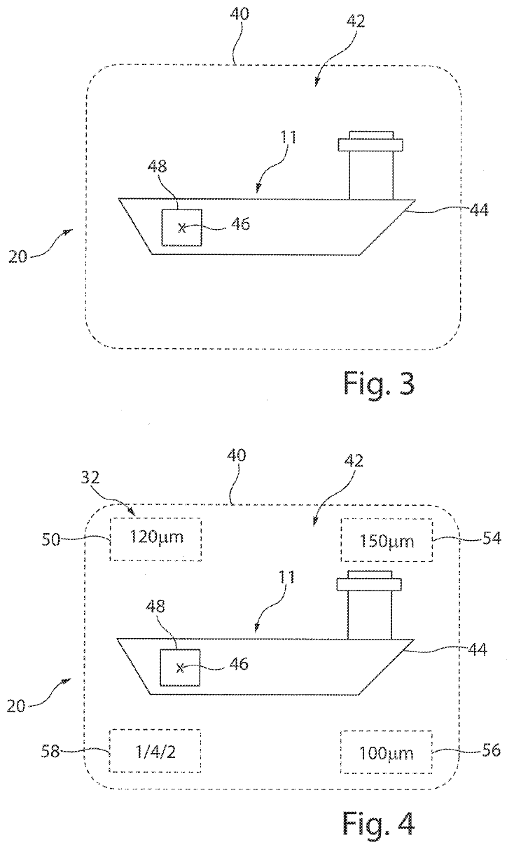

FIG. 3 shows the depiction of an image presentation 42 of the measurement object 1 with superimposed user guidance 48 through the data glasses 20. The data glasses 20 present surface information in the form of a spatially resolved surface presentation 44 in a projection surface 40. The image presentation 42 showing the measurement object 11 is projected onto this projection surface 40. The surface information may reproduce the spatially resolved surface presentation 44 of the measurement object 11, in this case the surface presentation of a ship. Generally, the surface presentation 44 of the measurement object 11 will be reproduced on a significantly larger scale. In this case, the presentation is merely schematic.

The surface presentation 44 of the measurement object 11 and the target measurement positions 46 are reproduced in the projection surface 40 before a measurement value 32 is detected. The image presentation 42 comprises a user guidance 48 which indicates for which target measurement position 46 at least one measurement value 32 is to be determined next. Because the image presentation 42 is at least partially transparent, the image presentation 42 is superimposed with real information of the measurement object 11. The user guidance 48 then enables the user to find the corresponding target measurement position 46 in a particularly simple and reproducible manner, so that the measurement value can also be detected in conformity with the particular target measurement position 46.

FIG. 4 shows a schematic depiction of an image presentation 42 of the measurement object 11 with a measurement value 32 and additional information 58. The measurement value 32 can in turn be correlated with at least one piece of surface information of the measurement object 11. In addition, the image presentation 42 comprises quality information 50 of the measurement value 32. The limit value range 54, 56 indicates the interval within which the particular measurement value 32 should lie for the particular target measurement position. The quality information 50 then indicates whether the measurement value 32 lies within the limit value range. For example, the measurement value 32 can be coloured according to a first colour (green) for a first piece of quality information 50 if the measurement value 32 is within the limit value range. Otherwise, the quality information 50 can be coloured according to another colour (red). The user is thus shown in a particularly simple and efficient manner the relationship between the measurement value 32 and the limits of the limit value range.

In addition, the image presentation 42 comprises the spatially resolved surface presentation 44 of the measurement object 11 already described above and the user guidance 48 corresponding to the particular target measurement position 46. The user is thus also shown in relation to which target measurement position 46 the detected measurement value 32 is assigned.

In an embodiment, the image presentation 42 of the measurement value 32 is additionally correlated with further additional information 58, which is also reproduced. The additional information 58 includes an indication of the position and/or location of the target measurement area region (“1”), a number of target measurement points (“4”) within the predetermined target area measurement region and a repetition stage of measurements (“2”) at the various target measurement points. The surface of the measurement object 11 is divided into target measurement area regions according to a predetermined test pattern. The additional information 58 assists the user in actuating the next target measurement position 46 within the target measurement area region.

Subsequently, the relevant number of repetitions of measurements at the specified measurement points can be acknowledged so that the user moves on to the next target measurement point. At this measurement point, the number of repeated measurements can be carried out again. This makes it easy for the user to complete a given test pattern with a high degree of certainty.

The specific devices and portions or elements of devices described herein are not required and may be substituted for one or more different devices or elements. Additional devices and elements of devices may also be included though not described or illustrated herein. One or more methods or steps of a method described herein may not be performed, or steps or methods may be performed in addition to those described. Still further, the sequence in which methods or steps of methods are listed are not necessarily the order in which they are performed. Also, the concepts have been described with reference to specific embodiments. However, one of ordinary skill in the art appreciates that various modifications and changes can be made without departing from the scope of the claims as set forth below. Accordingly, the specification and figures are to be regarded in an illustrative rather than a restrictive sense, and all such modifications are intended to be included within the scope of the claims.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

Although multiple embodiments have been illustrated in the accompanying Drawings and described in the foregoing Detailed Description, it should be understood that the claims are not limited to the disclosed embodiments, but is capable of numerous rearrangements, modifications, and substitutions without departing from the scope thereof.

1. Method for tactile measurement on a surface of a measurement object, comprising:
obtaining by a pair of glasses at least one measurement value of the surface of the measurement object, wherein the at least one measurement value is detected by a tactile measuring probe; and
generating an image presentation in data glasses, wherein the image presentation includes the at least one measurement value.

2. Method according to claim 1, wherein the image presentation of the at least one measurement value in the data glasses is at least partially transparent, so that the image presentation is superimposed with information from the environment.

3. Method according to claim 1, wherein the at least one measurement value is correlated by a data processing device with at least one piece of quality information, and in that the at least one measurement value with the relevant correlated quality information is transmitted to the data glasses and reproduced in the image presentation.

4. Method according to claim 3, wherein the at least one measurement value is correlated by the data processing device with at least one upper and/or one lower limit value of a limit value range, and the upper and/or lower limit value of the limit value range for the measurement value is transmitted to the data glasses and reproduced in the image presentation.

5. Method according to claim 1, wherein at least one piece of surface information of the measurement object or a spatially resolved surface presentation of the measurement object, is provided to the data glasses and is reproduced in the image presentation.

6. Method according to claim 5, wherein a change is triggered between an image presentation of the at least one piece of surface information and an image presentation of the at least one measurement value, or the two are displayed superimposed on one another or next to one another.

7. Method according to claim 5, wherein the data processing device transmits to the data glasses at least one target measurement position at which at least one measurement value is to be determined.

8. Method according to claim 7, wherein the spatially resolved surface presentation is reproduced superimposed with the target measurement position before a measurement value is detected and the image presentation is at least partially transparent.

9. Method according claim 5, wherein the at least one piece of surface information with the target measurement position is correlated by the data processing device with the currently recorded measurement values of the tactile measuring probe, and the information correlated in this way is transmitted to the data glasses, so that the previous and/or the current measurement positions and/or the old measurement values and/or current measurement values of the tactile measuring probe are reproduced by the data glasses in the spatially resolved surface presentation of the measurement object.

10. Method according to claim 5, wherein the at least one surface information of the measurement object is provided by a data memory coupled to the data processing device and/or by a LIDAR sensor element.

11. Method according to claim 10, wherein the LIDAR sensor element is arranged on the data glasses.

12. Method according to claim 1, wherein the at least measurement value is correlated with position quality information by a data processing device, and the at least measurement value with the relevant correlated position quality information is transmitted to the data glasses and reproduced there.

13. Method according to claim 12, wherein the position quality information indicates whether a distance between an actual measurement position and a target measurement position is within or outside a limit value, and the actual measurement position at which a measurement value was detected is provided by a position detection element coupled to the tactile measuring probe.

14. Method according to claim 1, wherein at least one piece of additional information comprising a target area measurement region and/or a target measurement point and/or a repetition stage of the target measurement point is transmitted by the data processing device to the data glasses and reproduced there.

15. Method according to claim 14, wherein the respective piece of additional information is reproduced before or during the detection of a measurement value.

16. Method according to claim 1, wherein the measurement values are transmitted to the data processing device by the tactile measuring probe, and the data processing device is provided externally or internally to the measuring probe.

17. Method according to claim 1, wherein a data transmission between the tactile measuring probe and the data processing device and/or between the data processing device and the data glasses is wireless.

18. System for tactile measurement on a surface of a measurement object, comprising:
at least one measuring probe configured to obtain at least one measurement value of the surface of the measurement object;
a pair of data glasses configured to generate an image presentation in data glasses, wherein the image presentation includes the at least one measurement value; and
a data processing device.

19. System according to claim 18, wherein the system is designed for layer thickness measurement on a surface of a measurement object.

20. System according to claim 18, wherein the data glasses are designed as protective glasses; and
wherein the data processing device is configured to correlate the at least one measurement value with at least one piece of quality information and transmit the at least one measurement value with the correlated at least one piece of quality information to the data glasses for inclusion in the image presentation.
